(19) United States
(12) Patent Application Publication
(10) Pub. No.: US 2022/0379645 A1
(43) Pub. Date: Dec. 1, 2022

(54) Thermal Adhesive Paper

(71) Applicant: PanaMarc Corporation, Toronto (CA)

(72) Inventor: Peter Zosimadis, Toronto (CA)

(21) Appl. No.: 17/826,559

(22) Filed: May 27, 2022

Related U.S. Application Data
(60) Provisional application No. 63/195,493, filed on Jun. 1, 2021.

(51) Int. Cl. B41M 5/40; B41M 5/382

(52) U.S. Cl. CPC B41M 5/40; B41M 5/38214

(57) ABSTRACT

A thermal adhesive paper including a base stock with a thermal ink layer covering at least a portion of the base stock top surface and an activatable adhesive layer covering at least a portion of the base stock bottom surface is described. The thermal adhesive layer can be used in a thermal printer for printing a transaction receipt, with the adhesive being selectively activated during printing. The activatable adhesive may be thermally activated, with a higher temperature needed to activate the adhesive than to activate the thermal ink.

### CROSS-REFERENCE TO RELATED APPLICATION

This application is a U.S. Non-Provisional application that claims priority to U.S. Provisional Patent Application No. 63/195,493, filed Jun. 1, 2021, which is hereby incorporated by reference in its entirety.

### FIELD OF THE INVENTION

The invention relates to the field of printing, and more specifically to thermal paper and adhesive paper.

### BACKGROUND

Various types of paper and printing devices are used in the field of printing. One type of commonly used paper is thermal paper, which includes a special coating or ink layer that changes color when exposed to heat. The dye is often black, but it can also be another color, for example blue or pink. Thermal paper is used with a thermal printer to activate dye in the ink layer to produce an image and/or text on the thermal paper. A thermal printer generally includes a thermal printer head having many small heating elements which heat the ink layer in the thermal paper as the paper passes over the print head. The heating elements quickly heat the ink layer to a certain temperature, for example 100° C., which releases the dye in the ink layer. Specific images, letters, numbers and/or symbols are created on the thermal paper by electronically controlling the signals to the printer head—for example pulse length and intensity—to control the temperature of each heating elements.

Thermal paper is commonly used for applications where compact thermal printers that require minimal maintenance are beneficial. Such uses include printing point-of-sale receipts, labels, tickets, medical charts and more.

Printer paper sometimes includes an adhesive layer on the underside of the paper so that the printed material can be stuck onto another item, which is the case for printed labels. An adhesive paper often includes a backing/cover layer over the adhesive which is removed to expose the adhesive layer for use. Alternatively, or in addition, the adhesive layer may be activatable such that is not sticky unless it is activated, which may be done by heating the adhesive layer. U.S. Patent Publication 2019/0051219; U.S. Patent Publication 2017/0337851; JP Patent Publication 2012062377A; JP Patent 10,240,132; JP Patent Publication 2014/177550; JP Patent Publication 2010/145844 and U.S. Pat. No. 9,321,294 teach label paper with an activatable adhesive.

Various activatable adhesive compositions are described in the prior art, including U.S. Patent Publication 2013/0156987; U.S. Pat. No. 6,461,722 and PCT Publication WO 2014/041239.

Various thermal printing devices are described in the prior art, including U.S. Pat. Nos. 7,102,658; 7,808,517 and JP Patent Publication 2004/025504. U.S. Pat. No. 7,816,302 teaches a printable identification medium for use with thermal printers.

### SUMMARY

In accordance with the invention, there is provided a thermal adhesive paper for use in a thermal printer comprising: a base stock having a top surface and a bottom surface; a thermal ink layer covering at least a portion of the base stock top surface that changes color upon thermal activation; and an adhesive layer covering at least a portion of the base stock bottom surface that is activatable to become tacky upon exposure to an activation trigger.

The thermal adhesive paper may further comprise any one or combination of the following layers: a pre coat layer between the thermal ink layer and the base stock; a top coat layer over a top surface of the thermal ink layer; and an insulating layer between the thermal ink layer and the adhesive layer.

The activation trigger may be heat. The adhesive layer may require a different temperature for activation than the thermal ink layer. The minimum temperature for activating the thermal ink layer may be higher than a minimum temperature for activating the adhesive layer.

The thermal adhesive paper may be in the form of a roll that fits into the thermal printer.

The adhesive layer may cover the entire base stock bottom surface. Alternatively, the adhesive layer may cover a portion of the base stock bottom surface. The portion may be less than 80% of the base stock bottom surface, or less than 70% of the base stock bottom surface, or less than 60% of the base stock bottom surface, or less than 50% of the base stock bottom surface, or less than 40% of the base stock bottom surface, or less than 30% of the base stock bottom surface, or less than 20% of the base stock bottom surface, or less than 10% of the base stock bottom surface.

The adhesive layer may cover a strip near one or both longitudinal edges of the base stock bottom surface. The strip may be directly adjacent the longitudinal edge of the base stock bottom surface or there may be a gap between the longitudinal edge of the base stock bottom surface and the strip of adhesive layer. The strip may be less than 50% of the width of the base stock, preferably less than 40% of the width of the base stock, preferably less than 30% of the width of the base stock, and preferably less than 20% of the width of the base stock.

The thermal ink layer may be activated without activating the adhesive layer. Activating the adhesive layer may activate the thermal ink layer.

In accordance with an aspect, there is provided use of the thermal adhesive paper in the thermal printer for printing a receipt, wherein selected portions of the thermal ink layer and/or the adhesive layer are activated by the thermal printer to produce the printed receipt. The thermal ink layer and the adhesive layer may be activated concurrently by the thermal printer.

The thermal printer may be a point of sale terminal. The point of sale terminal may be an existing point of sale terminal. The existing point of sale terminal may be retrofit for use with the thermal paper via a software upgrade and/or software installation. The point of sale terminal may be a debit and/or credit card reader.

The adhesive layer may be activated by heat from a thermal print head in the thermal printer. The heat may be in the form of any one or combination of: radio frequency energy, inductive heat, radiant heat and visible light. The thermal ink layer and/or the adhesive layer may be selectively activated as the thermal adhesive paper passes by the thermal print head. Selectively activating the thermal ink layer and/or the adhesive layer may be done by controlling the temperature of the thermal print head.

The printed receipt may comprise activated thermal ink forming a text and/or image on the top surface above the activated adhesive layer on the bottom surface, the text and/or image providing a visual indication where the adhesive has been activated. The image and/or text may be located in a top corner of the printed receipt. The image and/or text may comprise a line that mimics a staple. The image and/or text may be located adjacent one or more edges of the printed receipt. The image and/or text may comprise a colored strip adjacent one or more edges of the printed receipt. The image and/or text may comprise an advertisement.

In some aspects, there is provided a method for printing and activating an adhesive on a thermal adhesive paper using a thermal printer having a thermal print head comprising the steps: a) controlling the thermal print head to thermally print an image and/or text on a top surface of the thermal adhesive paper; and b) controlling the thermal print head to activate an adhesive on at least one section of a bottom surface of the thermal adhesive paper.

Controlling the thermal print head in steps a) and b) may comprise controlling the temperature of the thermal print head. Step a) may comprise controlling the thermal print head to a first minimum temperature and step b) may comprise controlling the thermal print head to a second minimum temperature. The second minimum temperature may be higher than the first minimum temperature. In step b) activating the adhesive may activate the thermal ink layer concurrently.

The method may produce a printed receipt. The thermal printer may be a point of sale terminal.

The method may use the thermal adhesive paper as described above.

Upon activation of the adhesive layer, the adhesive layer may immediately become tacky. Alternatively, the activated adhesive layer may become tacky after an activation time period has passed. The activated adhesive layer may include an open time window where the activated adhesive layer is tacky and can adhere to a surface. After the open time window ends, the activated adhesive layer is no longer tacky.

In some embodiments, the activation trigger is UV light and/or moisture.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1 is a side view of a thermal adhesive paper in accordance with one embodiment.

FIG. 2A is a bottom view of a thermal adhesive paper showing the activatable adhesive layer covering the longitudinal edges of the bottom surface in accordance with one embodiment.

FIG. 2B is a bottom view of a thermal adhesive paper showing the activatable adhesive layer covering one longitudinal edge of the bottom surface in accordance with one embodiment.

FIG. 3 is a schematic of a thermal printer showing the relationship between a thermal printer head and a thermal adhesive paper in accordance with one embodiment.

FIG. 4 is a top view of a receipt showing a colored line in the top left corner mimicking a staple where the adhesive has been activated on the bottom surface of the receipt in accordance with one embodiment.

FIG. 5 is a top view of a receipt showing a colored line on the left side where the adhesive has been activated on the bottom surface of the receipt in accordance with one embodiment.

FIG. 6 is a top view of a receipt showing text where the adhesive has been activated on the bottom surface of the receipt in accordance with one embodiment.

FIG. 7 is a top view of a receipt showing an advertisement where the adhesive has been activated on the bottom surface of the receipt in accordance with one embodiment.

FIG. 8 is a top view of a receipt showing a circle with the word “press” where the adhesive has been activated on the bottom surface of the receipt in accordance with one embodiment.

FIG. 9 is a side view of a thermal adhesive paper having additional layers in accordance with one embodiment.

FIG. 10 is a top perspective view of a roll of thermal adhesive paper in accordance with one embodiment.

### DETAILED DESCRIPTION

### Rationale

A thermal printer paper with an activatable adhesive is described.

The inventor has realized the need for a thermal printer paper that includes an activatable adhesive, preferably on the back side of the paper, that can be selectively activated during the printing process and does not require a backing/cover layer to be removed.

Activatable adhesives may be used on printer paper, but they generally require a separate step and/or device for activating the adhesive after printing. Again, this is time consuming and cumbersome, and it requires additional equipment at an additional cost.

The inventor has realized a need for a thermal paper with an activatable adhesive, wherein the adhesive is preferably activated during thermal printing. The inventor has further realized the need for a thermal adhesive paper that can be used as a receipt paper, for example in a point of sale (POS) system to provide a user with an adhesive receipt.

POS systems come in a variety of forms. A POS system often includes two receipt printers: one for printing an itemized receipt and a second for printing a debit/credit card transaction receipt. One or both of the printers are often thermal printers that print on thermal receipt paper. Since a purchaser often wants to keep the two receipts together, a vendor may staple the receipts together after printing. This is however an additional step that takes time and slows down a retail transaction. It also requires the vendor to have a functional stapler on hand, as well as extra staples to refill the stapler when needed. This is all quite cumbersome for a vendor and leads to additional costs and time. Many vendors forego stapling receipts together, in which case the purchaser must take responsibility for keeping the receipts together. This can lead to lost receipts and mix-ups. Some purchasers may staple the receipts together themselves when they return to their office or home and have access to a stapler.

The aforementioned problems are solved by the thermal adhesive paper that is used with a POS system. During printing of the receipt on the thermal adhesive paper, the adhesive can be activated. For example, a user may choose for the adhesive to be activated on a credit/debit transaction receipt so they can adhere the credit/debit card transaction receipt to the itemized receipt they receive for the purchase at the same time. If a purchaser does not want an adhesive receipt, the adhesive is simply not activated during printing.

### The Thermal Adhesive Paper

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

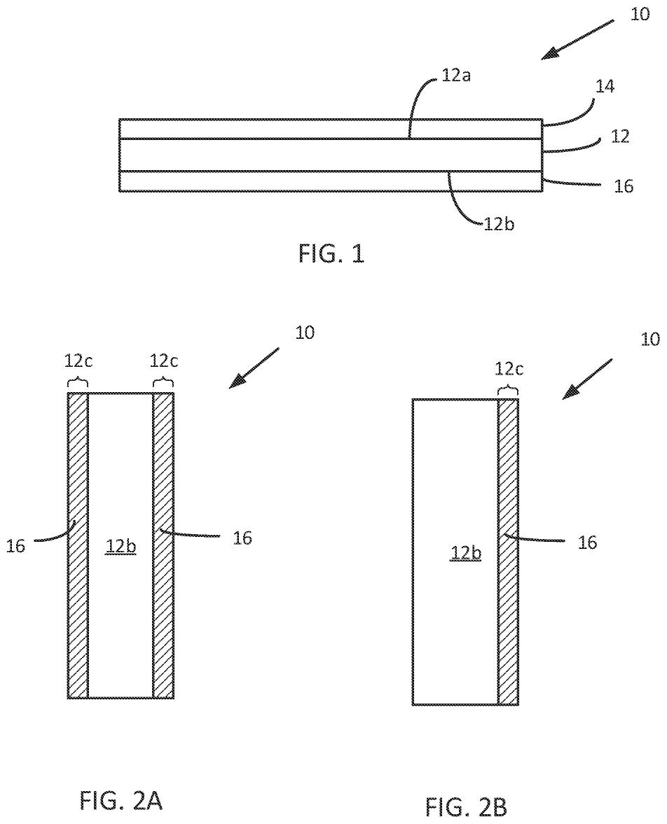

Referring to FIG. 1, the thermal adhesive paper 10 generally comprises a base stock 12 having a top surface 12a and a bottom surface 12b, a thermal ink layer 14 adjacent the top surface 12a and an activatable adhesive layer 16 adjacent the bottom surface 12b.

The base stock 12 is a substrate that is compatible with thermal printing. The base stock may be a paper or a synthetic base sheet.

### Thermal Ink Layer

The thermal ink layer 14 generally comprises a dye that changes color when exposed to heat. Thermal ink layers generally include the following components:
A color former such as a leuco dye that is colorless in crystalline form and/or when in a pH neutral environment and becomes colored when dissolved in a melt and/or exposed to an acidic environment. Examples include triaryl methane phthalide dyes and fluoran dyes.
A color developer that combines with the color former to develop the color change. A developer generally includes one or more organic acids. Examples of suitable organic acids include phenols such as Bisphenol A (BPA) and Bisphenol S (BPS), sulfonyl ureas such as BTUM and Pergafast® 201, and zinc salts of salicylic acids such as zinc di-tert-butylsalicylate.
A sensitizer to affect the thermal threshold at which the color former and color developer melt and mix together to change the ink to the colored form. Examples include 1,2-bis-(3-methylphenoxy)ethane and 2-benzyloxynapthalene which melt at approximately 100° C.
A stabilizer to stabilize the state of the color former when it has transitioned to the colored form and prevent it from returning to the colorless state.

### Activatable Adhesive Layer

The activatable adhesive layer 16 includes an adhesive that switches from a non-tacky to a tacky state upon activation. The adhesive will not adhere to a surface until it has been activated and is in the tacky state. Various activation triggers can be used to activate the adhesive, including the application of heat, light, moisture and/or pressure.

The activatable adhesive layer 16 may cover the entire bottom surface of the thermal adhesive paper 10 or it may cover only portions of the bottom surface of the thermal adhesive paper. For example, as shown in FIG. 2A, the activatable adhesive layer 16 may cover both the longitudinal edges 12c of the base stock bottom surface 12b. Alternatively, as shown in FIG. 2B, the activatable adhesive layer 16 may cover only one of the longitudinal edges 12c of the base stock bottom surface 12b.

The time required to convert the adhesive from a non-tacky to a tacky state can vary after exposure to an activation trigger, which may be the application of heat to the adhesive. The adhesive may convert to a tacky state almost immediately, such as less than 1 second or even less than 0.5 seconds. Alternatively, the activation time may be longer, such as from 1 second to 60 seconds, or even longer such as 1 to 60 minutes or more. The desired activation time may depend on a couple factors, such as how long it takes the thermal adhesive paper to exit the printer. It may be preferable that the adhesive does not become tacky while it is in the printer since this could adversely affect the operation of the printer. The activation time may also depend on the intended outcome for the thermal adhesive paper, and specifically how much time a user may need to position the printed thermal adhesive paper in its intended position. For example, a user may want to adhere the thermal adhesive paper to another surface immediately, in which time a fast activation time is ideal. Alternatively, the user may want to adhere the thermal adhesive paper to another surface after 5 minutes have passed, in which case it may be ideal for the adhesive to not become tacky for a few minutes after it is activated.

The activated adhesive may not remain in the tacky state permanently, but may have an open window in which it remains tacky and can be adhered to a surface before the window closes and the adhesive is no longer tacky. For example, the open window may be from 5 seconds to 10 minutes. The open window may be even longer, such as up to an hour, or even several hours or several days. The desired time for the open window will depend on the intended application and the time needed to adhere the thermal adhesive paper to a surface.

A number of compositions can be used for the activatable adhesive layer. The main components generally include a tackifier which softens upon activation to become tacky and a plasticizer which melts upon activation to blend with the tackifier and convert the adhesive layer to a tacky state. One or more base components are generally included, such as a base polymer which may also melt upon activation to allow the components to mix.

The activatable adhesive layer may be a thermally activated adhesive, in which case heat can be applied using a variety of means, including radio frequency (RF) energy, inductive heat, radiant heat and visible light.

### Additional Layers

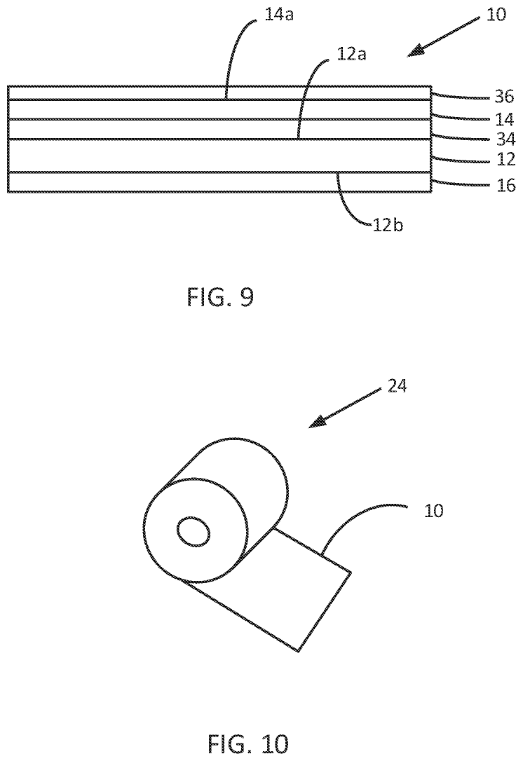

The thermal adhesive paper 10 may include one or more additional layers, detailed below and shown in FIG. 9.

A pre coat layer 34 may be used between the top surface 12a of the base stock 12 and the thermal ink layer 14. The pre-coat layer 34 can seal the base stock 12 to provide for better adhesion of the thermal ink layer 14. The pre-coat layer may also provide heat insulation properties between the thermal ink layer and the base stock. The pre-coat layer may also improve other qualities of the paper, including smoothness and uniformity. The pre-coat layer may be one single layer or multiple layers that provide various properties.

A topcoat layer 36 may be applied to the top surface 14a of the thermal ink layer 14 to seal the thermal ink layer. The topcoat layer is generally translucent and while not necessary, can be used to provide additional protection to the thermal ink layer. A topcoat is particularly useful for applications where a longer image life on the thermal adhesive paper is desired, or where the thermal adhesive paper 10 will be subjected to harsh environmental conditions like exposure to UV light, water and other substances.

There may be one or more insulating layers (not shown) between the thermal ink layer 14 and the activatable adhesive layer 16 to prevent heat transfer between these two layers. In the case of a heat-activated adhesive, the insulating layer may prevent the thermal ink layer 14 from being activated during activation of the adhesive, and vice versa.

### Form of Thermal Adhesive Paper

The thermal adhesive paper 10 is preferably manufactured as a roll 24 of receipt paper, as shown in FIG. 10. The width, length and thickness of the thermal adhesive paper roll 24 will depend on the thermal printer that the roll is designed to fit into it. Generally, the thermal adhesive paper roll 24 is sized to fit into a typical credit card terminal and/or point of sale terminal where thermal receipts are printed. The width is preferably about 4 cm (1.6 inches) to about 11 cm (4.3 inches), and more preferably about 5.5 cm (2.2 inches) to about 8 cm (3.1 inches). The length is preferably about 6 m (19.7 feet) to about 150 m (492 feet), and more preferably about 10 m (32.8 feet) to about 75 m (246 feet). The thermal adhesive paper thickness is preferably about 25 μm to about 500 μm, more preferably about 25 μm to about 250 μm, more preferably about 25 μm to about 175 μm, and more preferably about 40 μm to about 100 μm.

### Activating the Adhesive Layer

In the case of a thermally activated adhesive layer, the adhesive layer is preferably activated by the thermal printer that is used for printing on the thermal adhesive paper 10. The same thermal print head that prints on the thermal paper may activate the adhesive as the adhesive layer passes by the thermal print head. Alternatively, a second thermal print head in the same printer may activate the adhesive.

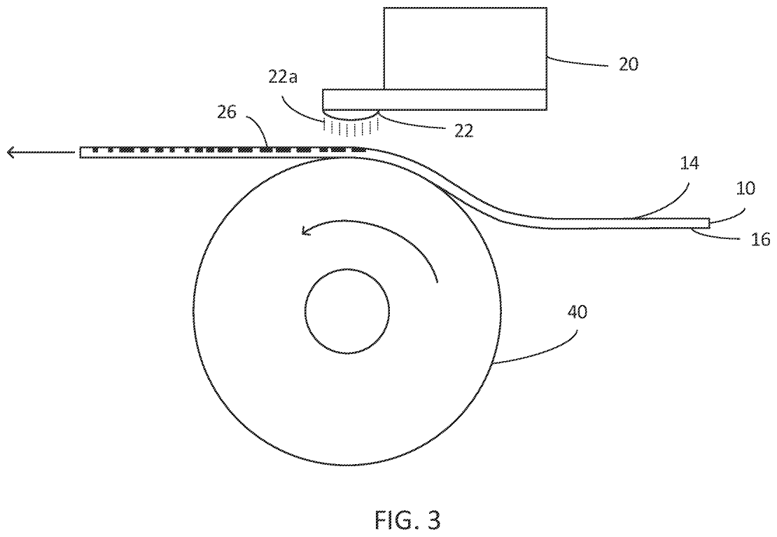

For example, FIG. 3 illustrates a thermal printer having a thermal print head 20 with heating elements 22 and roller 40 for rotating and moving the thermal adhesive paper 10 past the thermal print head. The thermal ink layer 14 is on the top surface of the thermal adhesive paper 10, facing the heating elements. The activatable adhesive layer 16 is on the bottom surface of the thermal adhesive paper 10. The thermal adhesive paper 10 passes by thermal print head 20 in the direction of the arrows as the thermal print head is controlled to give off heat 22a to activate the thermal ink layer to print an image/text 26 on the top surface of the thermal adhesive paper 10 and/or to activate the adhesive on the bottom surface of the thermal adhesive paper.

Preferably, a first temperature activates the thermal ink layer and a second temperature activates the adhesive layer. The temperature for activating the adhesive may be higher than the temperature for activating the thermal ink. For example, the thermal ink layer 14 may be activated at a temperature of 100° C. or higher, and the adhesive layer 16 may be activated at a temperature of 150° C. or higher.

Alternatively, the temperature range in which the adhesive layer and/or thermal ink layer are activated could be a range. For example, the thermal ink layer 14 may be activated at a temperature of 100 to 150° C., and the adhesive layer 16 may be activated at a temperature of 175 to 225° C. In this case, applying a temperature in the higher range that activates the adhesive layer would not activate the thermal ink layer. Alternatively, the temperature range to activate the adhesive layer may be lower than the temperature range to activate the thermal ink layer. In this case, applying a temperature in the lower range would activate the adhesive but not the thermal ink, and applying a temperature in the higher range would activate the thermal ink but not the adhesive.

The thermal printer includes a controller to control the temperature of the thermal print head(s). Therefore, the temperature of the thermal printer head(s) can be readily adjusted through the use of software that acts on the controller. This allows an existing thermal printer, such as a POS terminal and/or credit card terminal, to be adapted for use with the thermal adhesive paper through a software update, which is fairly easy, quick and inexpensive.

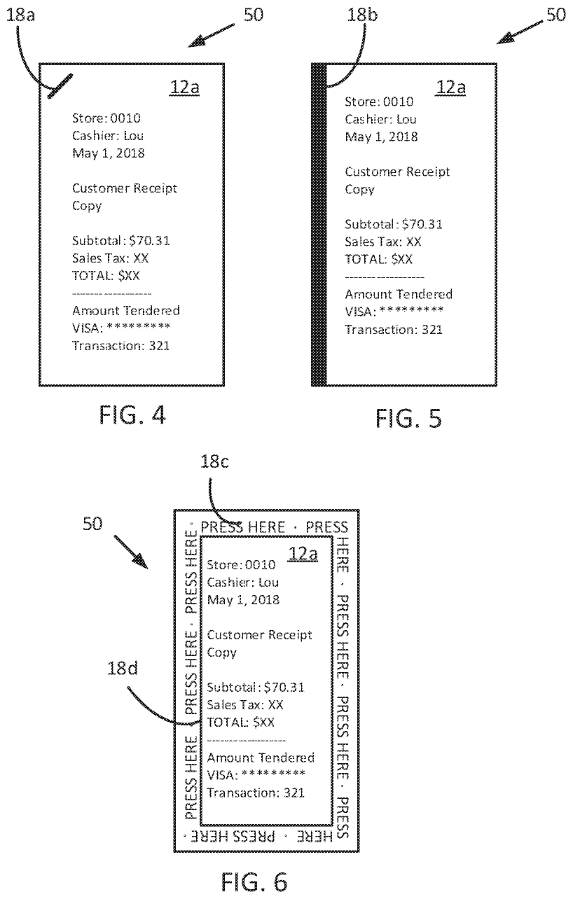

In the example shown in FIG. 3, the thermal print head 20 faces the thermal ink layer 14. In this case, if the minimum temperature needed to activate the adhesive is higher than the minimum temperature needed to activate the thermal ink layer, the thermal ink layer 14 will be activated upon activating the adhesive. This will cause the dye to convert to its colored form on the top surface of the paper directly adjacent where the adhesive has been activated on the bottom surface of the paper. To avoid the entire thermal adhesive paper from being colored, which would not allow for a legible image/text, the adhesive may be activated only in certain areas. In the areas where the adhesive is activated, the thermal ink is also activated to show an image, text and/or a solid section of ink on the top surface 12a of the thermal adhesive paper. The activated ink section can indicate to a user where the activated adhesive is, so the user knows where to press on the top surface of the thermal adhesive paper to adhere the thermal adhesive paper to a surface. Example configurations of the activated adhesive layer are shown in FIGS. 4 to 8 which each show a printed paper 50, for example a receipt paper.

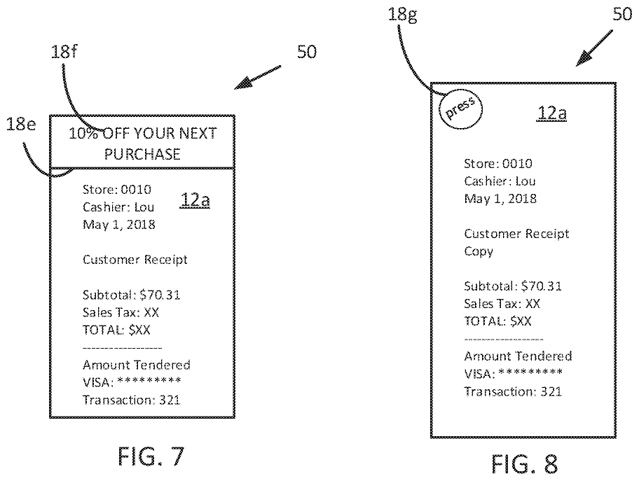

As shown in FIG. 4, the adhesive may be activated as a line 18a in the top left corner of the printed paper 50, mimicking a staple. In another example, shown in FIG. 5, the adhesive may only be activated on the left side of the printed paper 50, which appears as a solid colored line 18b on the top surface 12a of the paper. Alternatively, text and/or images can be printed on the activated adhesive areas to indicate to a user where the adhesive is, as shown in FIGS. 6 and 8. For example, referring to FIG. 6, there may be text 18c indicating “Press Here” under which the adhesive is activated. There may also be a solid portion such as frame 18d under which the adhesive is activated, with the solid portion used to ensure enough adhesive is activated for the printed paper 50 to adhere to a surface. In another example, shown in FIG. 7, there is a solid line 18e with text 18f above it, which may include an advertisement, wherein the adhesive has been activated in the section under the solid line 18e and text 18f. In another example, shown in FIG. 8, there may be an image 18g such as a circle with text inside saying “press” to indicate where the activated adhesive is.

As indicated above, there may be different arrangements of the activatable adhesive layer 16 on the bottom surface 12b of the thermal adhesive paper 10 (i.e. only sections of the bottom surface may be covered with adhesive layer) which support different configurations of where the adhesive is activated. For example, having the activated adhesive layer 16 along the entire bottom surface as shown in FIG. 1 would allow for adhesive to be activated in any configuration, including those illustrated in FIGS. 4-8. Having the activated adhesive layer 16 along one or both longitudinal edges 12c of the bottom surface as shown in FIGS. 2A and 2B would allow for the adhesive to be activated in the configurations illustrated in FIGS. 4, 5 and 8.

In some embodiments, the thermal ink layer 14 may not be activated when the adhesive layer 16 is activated. This may be the case if the base stock bottom surface with the activatable adhesive layer faces the thermal printer head, and the heat transfer between the middle layers to the thermal ink layer during activation of the adhesive layer is not sufficient to activate the thermal ink layer. The middle layers include any layers between the thermal ink layer and the adhesive layer, including but not limited to the base stock 12, the precoat layer 34, and the insulating layer.

The thermal ink layer 14 may include two or more colors of dye that are activated at different temperatures. One color of dye may have the same or similar activation temperature as the activatable adhesive layer 16, such that areas of activated adhesive are apparent because the top surface of the thermal adhesive paper 10 appears that color (e.g. yellow).

Alternatively, the thermal printer may include other adhesive activation elements instead of or in addition to a thermal print head. The type of adhesive activation element will depend on the type of activatable adhesive layer. For example, the thermal printer may include a UV light as an activation element for a UV-activated adhesive. Alternatively, in the case of a moisture activated adhesive, the thermal printer may include an adhesive activation element that moistens the activatable adhesive layer.

### Example of Thermal Adhesive Paper in Operation

In one example of use of the thermal adhesive paper, a vendor loads a roll of thermal adhesive paper into a credit/debit card terminal. When a transaction occurs with a purchaser, the purchaser pays via credit card using the credit/debit card terminal and goes through any necessary prompts on the credit/debit card terminal display (e.g. confirming the purchase amount, entering a pin, swiping their card, etc.). The credit/debit card terminal display can also prompt the user “Do you want an adhesive receipt?”. If the user chooses no, a receipt is printed without activating the adhesive. If the user chooses yes, a controller in the credit/debit card terminal controls the thermal print head or other activation device in the credit/debit card terminal printer to activate the adhesive on the receipt as it is printed. The user can then stick the adhesive receipt onto the itemized receipt they also receive during the transaction. The user may be the purchaser or the vendor.

Although the present invention has been described and illustrated with respect to preferred embodiments and preferred uses thereof, it is not to be so limited since modifications and changes can be made therein which are within the full, intended scope of the invention as understood by those skilled in the art.

1. A thermal adhesive paper for use in a thermal printer comprising:
a base stock having a top surface and a bottom surface;
a thermal ink layer covering at least a portion of the base stock top surface that changes color upon thermal activation; and
an adhesive layer covering at least a portion of the base stock bottom surface that is activatable to become tacky upon exposure to an activation trigger.

2. The thermal adhesive paper of claim 1, wherein the activation trigger is heat.

3. The thermal adhesive paper of claim 2, wherein the adhesive layer requires a different temperature for activation than the thermal ink layer.

4. The thermal adhesive paper of claim 3, wherein a minimum temperature for activating the thermal ink layer is higher than a minimum temperature for activating the adhesive layer.

5. The thermal adhesive paper of claim 1, wherein the thermal adhesive paper is in the form of a roll that fits into the thermal printer.

6. The thermal adhesive paper of claim 1, wherein the adhesive layer covers the entire base stock bottom surface.

7. The thermal adhesive paper of claim 1, wherein the adhesive layer covers a portion of the base stock bottom surface.

8. The thermal adhesive paper of claim 7, wherein the adhesive layer covers a strip near one or both longitudinal edges of the base stock bottom surface.

9. The thermal adhesive paper of claim 1, wherein the thermal ink layer can be activated without activating the adhesive layer.

10. The thermal adhesive paper of claim 1, wherein activating the adhesive layer activates the thermal ink layer.

11. A method for printing and activating an adhesive on a thermal adhesive paper using a thermal printer having a thermal print head comprising the steps:
a) controlling the thermal print head to thermally print an image and/or text on a top surface of the thermal adhesive paper; and
b) controlling the thermal print head to activate an adhesive on at least one section of a bottom surface of the thermal adhesive paper.

12. The method of claim 11, wherein controlling the thermal print head in steps a) and b) comprises controlling the temperature of the thermal print head.

13. The method of claim 11, wherein step a) comprises controlling the thermal print head to a first minimum temperature and step b) comprises controlling the thermal print head to a second minimum temperature.

14. The method of claim 13, wherein the second minimum temperature is higher than the first minimum temperature.

15. The method of claim 11, wherein in step b), activating the adhesive activates the thermal ink layer concurrently.

16. The method of claim 11, wherein the method produces a printed receipt.

17. The method of claim 11, wherein the thermal printer is a point of sale terminal.

18. The method of claim 11, wherein the thermal adhesive paper comprises the thermal adhesive paper as defined in claim 1.
